(19) United States
(12) Patent Application Publication
(10) Pub. No.: US 2026/0132865 A1
(43) Pub. Date: May 14, 2026

(54) VALVE INTEGRATED PRESSURE REGULATOR (VIPR) ASSEMBLY WITH VISUAL ALERT INDICATOR

(71) Applicants: Dennis E. Reid, Woking (GB); Brian Jacobsen, Woking (GB); Raj Gupta, Woking (GB); Laurie M. O’Connor, Tonawanda, NY (US)

(72) Inventors: Dennis E. Reid, Woking (GB); Brian Jacobsen, Woking (GB); Raj Gupta, Woking (GB); Laurie M. O’Connor, Tonawanda, NY (US)

(21) Appl. No.: 19/065,156

(22) Filed: Feb. 27, 2025

Related U.S. Application Data
(60) Provisional application No. 63/720,309, filed on Nov. 14, 2024.

(51) Int. Cl. F16K 37/00; F16K 31/60

(52) U.S. Cl. CPC F16K 37/0025; F16K 31/60

(57) ABSTRACT

A valve integrated pressure regulator (VIPR) assembly is provided that includes a valve integrated pressure regulator device, a protective shroud, and a visual alert indicator. The visual alert indicator is disposed in operative association with the valve integrated pressure regulator device and the protective shroud such that it is externally visible from a front view, a back view, a right-side view, a left-side view and a top of the valve integrated pressure regulator assembly.

### CROSS REFERENCE TO RELATED APPLICATIONS

This application claims the benefit of and priority to United States provisional patent application Ser. No. 63/720,309 filed on Nov. 14, 2024 the disclosure of which is incorporated by reference.

### TECHNICAL FIELD

The present invention relates to a valve integrated pressure regulator (VIPR) assemblies used with compressed gas cylinders, and more particularly to visual alert indicators for a medical gas VIPR assemblies.

### BACKGROUND

Methods of providing a low pressure gas flow from a high pressure compressed gas cylinder typically require specially designed gas cylinder packages many of which employ a valve integrated pressure regulator (VIPR) device equipped with a pressure regulated gas outlet which can be set to discharge a low pressure gas at a fixed gas flow rate. Alternatively, a VIPR device can be designed or configured to provide a pressure regulated gas flow at two or more discrete gas flow settings.

Most VIPR assemblies typically include a protective shroud or cowling designed to protect the VIPR device. Examples of such protective shrouds or cowlings can be seen in the following prior art references: U.S. Pat. Nos. 7,237,570; 7,703,821; 8,002514; 8,162587; 8,534,312; and 9,874,312; as well as United States Patent Application Publication No.: 2017-114961 and European Patent Application Nos.: EP3002498; EP3377806; EP3267092; EP2715209; EP3531006; and EP3260760.

When used in busy hospital settings and other busy healthcare environments that use medical gas cylinders with VIPR assemblies, it is often difficult to tell when a medical gas cylinder and VIPR assembly not connected or being operated incorrectly, has some other mechanical/electrical problems, or when it is simply running out of medical gas product. To assist users of medical gas cylinders with VIPR assemblies to determine when such adverse conditions exist, many conventional medical gas cylinders use alarm indicators, including audible alarm indicators as well as limited visual alert indicators. Some of the above-identified VIPR assemblies with protective shrouds include audible alarm indicators or limited visual alert indicators. Most visible alarm indicators are typically integrated into the front-facing gauges or front-facing electronic displays which offers only a relatively narrow field of view and thereby restricts visibility of the alarm indicator.

What is needed are improved ergonomic VIPR assemblies for medical gas cylinder packages that provide enhanced visual alert indicators that can be seen from nearly all viewing angles.

### SUMMARY OF THE INVENTION

The present invention may be characterized as a valve integrated pressure regulator assembly configured to be attached to a compressed gas cylinder along a central axis of the compressed gas cylinder, the valve integrated pressure regulator assembly comprising: (i) a valve integrated pressure regulator device (ii) a protective shroud configured for covering or enveloping the valve integrated pressure regulator device, the protective shroud further having a plurality of openings to expose various components of the valve integrated pressure regulator device including a gas outlets; the one or more control knobs; and a pressure gauge or electronic display; and (iii) a visual alert indicator disposed in operative association with the valve integrated pressure regulator device and the protective shroud such that it is externally visible from a front view, a back view, a right-side view, a left-side view and a top of the valve integrated pressure regulator assembly.

The visual alert indicator preferably comprises a light source such as light emitting diodes (LEDs) disposed in a translucent or transparent casing and configured to emit one or more colors of light and when the valve integrated pressure regulator device detects one or more alarm condition or select operating conditions. A controller for the valve integrated pressure regulator device is configured to activate the visual alert indicator and emit the one or more colors of light in the one or more selected conditions.

Placement of the visual alert indicator is somewhat dependent on the configuration of the protective shroud. In some embodiments, the protective shroud further comprises a top section defining a handle and an exposed top surface, the top section further having a central opening configured to expose at least one of the one or more control knobs. The protective shroud may also include a bottom section having an annular protective collar. In such embodiments, the visual alert indicator is a collar disposed around the at least one of the one or more control knobs. Alternatively, the visual alert indicator may be disposed on or in the at least one of the one or more control knobs. Still further, the visual alert indicator may be disposed on the handle or on the exposed top surface or even on the protective collar.

In some embodiments, the visual alert indicator may comprise a plurality different colored or multi-colored light emitting diodes (LEDs) and wherein the different colors emitted indicate different alarm conditions, different operating conditions or cylinder status conditions. The plurality of light emitting diodes (LEDs) may be illuminated concurrently, sequentially, or in a pulsed sequence, and wherein the different illuminations indicate different alarm conditions, different operating conditions, or cylinder package status conditions.

As indicated above, in addition to alarm conditions, the visual alert indicator could be activated with a green light or pulsing pattern in normal operating conditions to indicate the gas is dispensing properly or even to mimic the patient respiratory pattern. It is also feasible to employ two or more visual alert indicators with each being activated in different alarm conditions. Lastly, in embodiments where the valve integrated pressure regulator device includes a wireless communications module, the visual alert indicator may be activated upon receipt of an external signal via the wireless communications module.

### BRIEF DESCRIPTION OF THE DRAWINGS

While the specification concludes with one or more claims specifically pointing out the subject matter that Applicants'regard as the invention, it is believed that the claims will be better understood when taken in connection with the accompanying drawing in which:

FIG. 1 is a perspective view of an embodiment of a valve integrated pressure regulator assembly;

FIG. 2 is a top view of the valve integrated pressure regulator assembly and encased within the protective shroud with the visual alert indicator disposed as a ring or collar disposed around a flow control knob;

FIG. 3 is a perspective view of an alternate embodiment of a valve integrated pressure regulator assembly; and

FIG. 4 is a partial perspective view of a flow control knob having the visual alert indicator integrated on an outside surface of the control knob.

### DETAILED DESCRIPTION

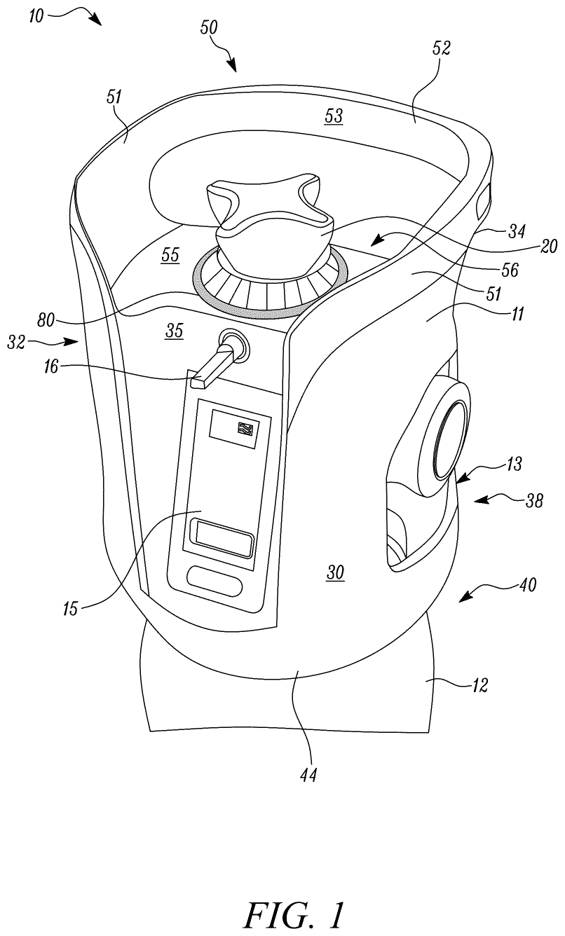

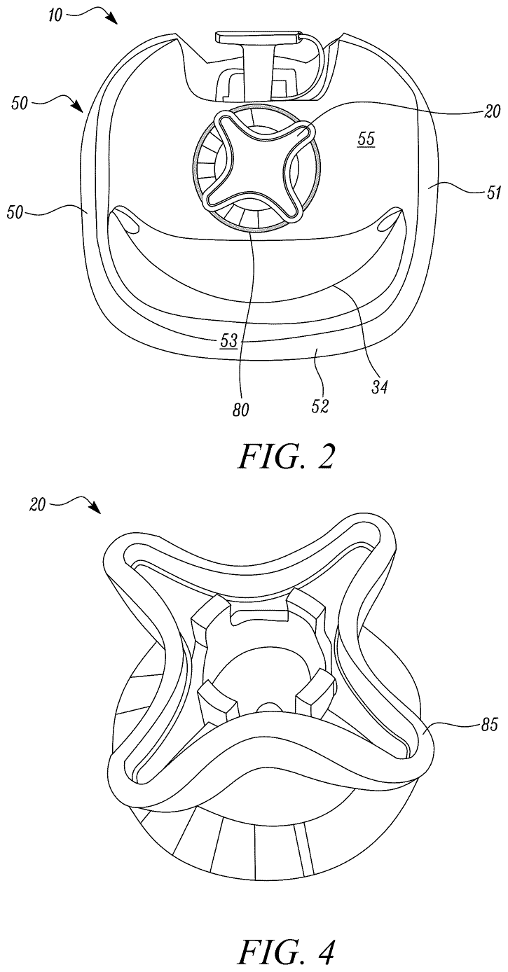

Turning now to FIGS. 1-2 of the drawings, an embodiment of a valve integrated pressure regulator (VIPR) assembly 10 for a pressurized gas cylinder 12 is shown. The VIPR device 13 is preferably encased within a protective shroud 11 and fitted with a visual alert indicator 80 as shown. When mounted or attached to a compressed gas cylinder 12 the VIPR assembly 10 (with VIPR device 13, protective shroud 11 and visual alert indicator 80) forms a valve integrated pressure regulator based cylinder package. Like many conventional VIPR devices, the present VIPR device 13 includes: a valve body; a cylinder connection, a plurality of values optionally including an isolation valve, a metering valve, and a pressure relief valve, a pressure regulator, one or more sensors, a controller, an electronic display 15; a gas fill port; at least one gas outlet 16, and a single control knob 20 configured to open and/or close the VIPR device 13 as well as regulate the gas flow from the compressed gas cylinder 12 to the gas inlet and through the VIPR to the gas outlet 16.

The illustrated protective shroud 11 includes a main body section 30 having a front face 32 with a recessed space 35. There are one or more openings configured to receive the electronic display 15 and the gas outlet 16 disposed on the recessed portion 35. In some embodiments, the opening for the electronic display 15 may be angled or inclined such that the exposed electronic display is also at an inclination relative to the central axis of the compressed gas cylinder 12.

The main body section 30 is a generally cylindrical looking shape but having a sculpted upper portion that transitions to a top section 50 and a primary handle 52 and exposed top surface 55. In the illustrated embodiment, the primary handle 52 includes one or more connecting sections or arms 51 and a curved grip section 53 that together with the exposed top surface forms the topmost portion of the protective shroud 11 and is circumferentially or arcuately disposed around the top opening 56 and control knob 20 with sufficient clearance between the grip section 53 of the primary handle 52 and the control knob 20. This clearance allows a user to easily turn the control knob 20 in a clockwise or counterclockwise direction. There is also sufficient clearance between the curved back face 34 of the main body section 30 and the primary handle 52 to easily allow an individual to easily grasp the grip section 53 of primary handle 52 from underneath. The primary handle 52 is oriented in a flat orientation in that it is generally aligned with or only slightly above the top of the control knob 20.

In addition to the main body section 30 and top section 50 (with primary handle 52), the protective shroud 11 also includes a bottom section 40 having a protective collar 44 circumventing the bottom of the VIPR assembly 10. The protective collar 44 is preferably an annular collar having a diameter that is equal to or less than a diameter of the compressed gas cylinder 12 to which the VIPR assembly 10 is attached.

In addition to openings on the front face 32 of the protective shroud 11, there are additional openings on the protective shroud 11 and which may include a top opening 56 through which the control knob 20 of the VIPR device 13 projects, a bottom opening (not shown) where the VIPR assembly 10 is connected to the compressed gas cylinder 12 and one or more side openings 38 on the main body section 30 configured to access a fill port, a pressure relief valve, quick connect, battery compartment or another feature of the valve integrated pressure regulator device. The main body section 30 may also include one or more removeable covers (not shown) that are positioned over the side openings 38 so as to cover the one or more side openings and protect the underlying structure or components of the VIPR device 13.

The illustrated primary handle 52 includes two parallel connecting arms or connecting sections 51 and a grip section 53 extending between the two parallel connecting sections 51. The grip section 53 is preferably a slightly outwardly curved grip section to allow sufficient clearance between the grip section 53 and the control knob 20 without extending beyond the circumference of the compressed gas cylinder to which the VIPR assembly 10 is attached. Likewise, the top opening 56 of the protective shroud 11 is sized to allow an individual to easily grasp and turn the control knob 20 of the VIPR device 13.

Preferably, the two parallel connecting sections 51 or arms and the grip section 53 of the primary handle 52 are in a planar orientation relative to one another and form the uppermost part of the protective shroud. As illustrated in the Figs., the parallel connecting sections 51 or arms are oriented in a generally orthogonal orientation relative to the to the grip section 53. In addition, the two parallel connecting sections 51 and grip section 53 are constructed in an orthogonal orientation to a central axis of the compressed gas cylinder.

The protective shroud 11 may be comprised or assembled from multiple sections. For example, the illustrated protective shroud 11 preferably comprises two or more non-symmetrical molded plastic structures attached to one another. However, VIPR assembly 10 together with the protective shroud 11 are designed to be attached and/or removed from the compressed gas cylinder 12 as an integrated assembly.

The visual alert indicator 80 is disposed in operative association with the valve integrated pressure regulator device and the protective shroud such that it is externally visible from a front view, a back view, a right-side view, a left-side view and a top of the valve integrated pressure regulator assembly. In other word, the visual alert indicator 80 has an ‘all-around’ visibility. More specifically, the visual alert indicator 80 is disposed in operative association with the controller of valve integrated pressure regulator device and configured to be activated based on various sensor inputs, cylinder package parameters, and/or operating conditions. Sensor inputs may include control knob position sensors, temperature sensors, pressure sensors, motion sensors, ambient condition sensors, etc., whereas cylinder package parameters may include parameters such as gas type, gas concentration, gas expiration date, cylinder size, cylinder tracking information, etc. Operating conditions associated with the visual alert indicator may include selected information or conditions such as fill mode operation, gas delivery mode operation, wireless communication mode, cylinder storage mode, etc.

In the illustrated embodiment FIGS. 1-2, the visual alert indicator 80 comprises a light source, which may be a plurality of light emitting diodes (LEDs) that are disposed in a translucent or transparent collar. The translucent or transparent collar is arranged in a circular pattern (or other 360 degree pattern) on or proximate to the exposed top surface of the protective shroud around the control knob and disperses the light in all directions. In the illustrated embodiment, the LEDs are preferably mounted on a printed circuit board (PCB) of the VIPR device which is located under the control knob. By arranging the LEDs on a PCB of the VIPR device under the control knob, little or no additional circuitry in the current design is required since a PCB may already be in place under the control knob in order to detect the position of the control knob. By using the same PCB to sense control knob position and for visual alert indicators, the design efforts and associates costs may be reduced and/or simplified.

The LEDs or other light source may be configured to emit one or more colors of light to enable different alarm conditions to be designated. The LEDs or other light sources are preferably illuminated by the controller that is associated with the VIPR device when an alarm condition is detected. The LEDs or other light sources may be illuminated all at once, or they can be pulsed, or they can be lit sequentially to create an animated lighting effect.

The visual alert indicator is preferably activated by a controller associated with the VIPR device when alarm conditions are detected. Examples of alarm conditions include: (i) pressure within gas cylinder is below a pressure threshold; (ii) a calculated time remaining parameter is below a time remaining threshold; (iii) no gas flow within the valve integrated pressure regulator device is detected; (iv) gas connections are disconnected or tubing is kinked; (v) one or more sensors or other components of the valve integrated pressure regulator device are malfunctioning; (vi) low battery charge is detected; (vii) gas temperatures are not within prescribed temperature ranges; (viii) gas flow conditions are inconsistent with flow setting; (ix) MRI field is detected; or (x) anomalies involving gas type, gas expiration date, cylinder condition are detected, etc.

The intensity of the LEDs or other light sources are chosen so that the visual alert indicator is visible in a wide range of ambient light conditions. In another contemplated embodiment of the VIPR assembly, an ambient light sensor (e.g. LDR sensor) can be used to adjust the brightness of the LEDs or other light source when, for example, the VIPR assembly and medical gas cylinder are used in low light conditions.

In addition, one or more surfaces the top section of the protective shroud are preferably formed or coated with reflective material such that the light emitted from the visual alert indicator reflects from the protective shroud itself, further improving the visibility of the visual alert indicator. This is especially useful in hospital settings where such protective shrouds for medical oxygen cylinders are advantageously colored white.

The present visual alert indicator is highly visible and externally visible all angles, including users looking at the VIPR assembly and gas cylinder from a front view, a back view, a right-side view, a left-side view and/or a top view. In other words, the visual alert indicator is visible from a full 360 degrees around the central axis of VIPR assembly and the medical gas cylinder.

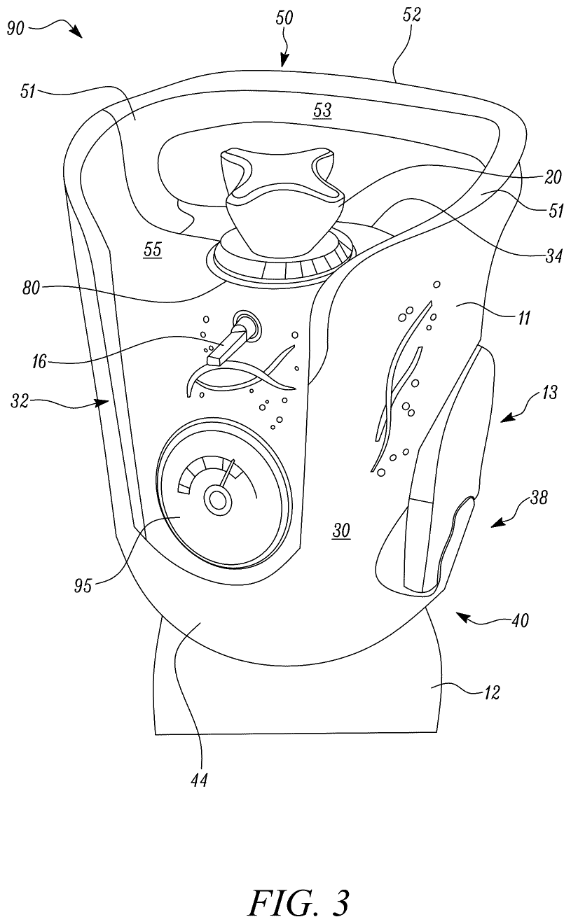

The alternate embodiment of the VIPR assembly 90 depicted in FIG. 3 includes an angled, luminescent pressure gauge 95 in lieu of the electronic display. The angled, luminescent pressure gauge 95 is viewable through an opening in the recessed portion of the protective shroud 11. The embodiment shown in FIG. 3 also includes the one or more protective covers as well as a single control knob that operates both as an ON/OFF knob as well as a flow control knob. Many of the other components of the VIPR device 13 and protective shroud 11, and visual alert indicator 80 are the same or similar to the above-described embodiments and for sake of brevity will not be repeated here. However, for the analog version of the VIPR device 13, an additional power source and PCB may need to be required in the VIPR device 13.

FIG. 4 shows a partial perspective view of a flow control knob 20 having the visual alert indicator 85 integrated on an outside surface of the control knob. This control knob 20 with integrated visual alert indicator 85 can be used in lieu of or in addition to the ring-shaped or collar shaped visual alert indicator 80 depicted in the embodiments of FIGS. 1-2.

Still further embodiments of the visual alert indicator can be disposed on the outside surface of the primary handle or on the outside surface of the protective collar, provided such visual alert indicators or reflections thereof can be

viewed from the front, back, right, left or overhead (i.e. top) of the VIPR assembly or cylinder package. As indicated above, it is contemplated that one or more visual alert indicators may be included within the VIPR assembly, with each such visual alert indicator signifying a different alarm condition or such one or more visual alert indicators can employ different colors to indicate different alarm conditions.

In still other contemplated embodiments, the visual alert indicator can be used to alert the status of the cylinder package in addition to various alarm conditions. For example if the VIPR assembly includes wireless communications capability, then a wireless transmission or signal could be sent to the VIPR assembly from a smartphone or other transmitting device and the visual alert indicator can be activated so users can more easily find the VIPR assembly and medical gas cylinder so activated. Such feature is particularly useful during cylinder inventory audits or queries where multiple visual alert indicators can be activated simultaneously to highlight the location of a specific cylinder or multiple cylinders (e.g. full cylinders or older cylinders).

While the present invention has been described with reference to a preferred embodiment or embodiments, it is understood that numerous additions, changes and omissions can be made without departing from the spirit and scope of the present invention as set forth in the appended claims.

What is claimed is:

1. A valve integrated pressure regulator assembly comprising:
a valve integrated pressure regulator device comprising a body; a gas inlet;
a gas outlet; a plurality of valves; a pressure regulator; one or more control knobs;
and a pressure gauge or an electronic display;
a protective shroud configured for covering or enveloping the valve integrated pressure regulator device, the protective shroud further having a plurality of openings to expose the gas outlet; the one or more control knobs; and the pressure gauge or the electronic display; and
a visual alert indicator disposed in operative association with the valve integrated pressure regulator device and the protective shroud such that it is externally visible from a front view, a back view, a right-side view, a left-side view and a top of the valve integrated pressure regulator assembly.

2. The valve integrated pressure regulator assembly of claim 1, wherein the protective shroud further comprises a top section defining a handle and an exposed top surface, the top section further having a central opening configured to expose at least one of the one or more control knobs.

3. The valve integrated pressure regulator assembly of claim 2, wherein the visual alert indicator is a collar disposed around the at least one of the one or more control knobs.

4. The valve integrated pressure regulator assembly of claim 2, wherein the visual alert indicator is disposed on or in the at least one of the one or more control knobs.

5. The valve integrated pressure regulator assembly of claim 2, wherein the visual alert indicator is disposed on the handle.

6. The valve integrated pressure regulator assembly of claim 2, wherein the visual alert indicator is disposed on the exposed top surface.

7. The valve integrated pressure regulator assembly of claim 2, wherein one or more surfaces the top section of the protective shroud are formed or coated with reflective material.

8. The valve integrated pressure regulator assembly of claim 2, wherein the at least one of the one or more control knobs are formed with translucent materials to disperse light.

9. The valve integrated pressure regulator assembly of claim 2, wherein the protective shroud further comprises:
a main body section having a front face with a recessed portion and a curved back face; and
a bottom section with a protective collar.

10. The valve integrated pressure regulator assembly of claim 9, wherein the visual alert indicator is disposed on the protective collar.

11. The valve integrated pressure regulator assembly of claim 9, wherein the front face with a recessed portion further comprises a first port configured to receive expose an angled electronic display.

12. The valve integrated pressure regulator assembly of claim 9, wherein the front face with a recessed portion further comprises a first port configured to expose an angled, luminescent analog pressure gauge.

13. The valve integrated pressure regulator assembly of claim 1, wherein the visual alert indicator further comprises a light source configured to emit one or more colors of light and wherein the valve integrated pressure regulator device further comprises a controller configured to activate the visual alert indicator and emit the one or more colors of light in one or more alarm conditions.

14. The valve integrated pressure regulator assembly of claim 13, wherein the visual alert indicator further comprises translucent materials configured to disperse light from the light source.

15. The valve integrated pressure regulator assembly of claim 13, wherein the visual alert indicator is connected to a printed circuit board of the valve integrated pressure regular device.

16. The valve integrated pressure regulator assembly of claim 13 wherein the visual alert indicator further comprises a plurality of light emitting diodes (LEDs).

17. The valve integrated pressure regulator assembly of claim 16 wherein the visual alert indicator further comprises different colored light emitting diodes (LEDs) and wherein the different colors emitted indicate different alarm conditions.

18. The valve integrated pressure regulator assembly of claim 16 wherein the plurality of light emitting diodes (LEDs) may be illuminated concurrently, sequentially, or in a pulsed sequence, and wherein the different illuminations indicate different alarm conditions.

19. The valve integrated pressure regulator assembly of claim 16 further comprising at least two visual alert indicators and the at least two visual alert indicators are each activated in different alarm conditions.

20. The valve integrated pressure regulator assembly of claim 1 wherein the valve integrated pressure regulator device further comprises a controller configured to activate the visual alert indicator in one or more alarm conditions selected from the following: (i) pressure within gas cylinder is below a pressure threshold; (ii) a calculated time remaining parameter is below a time remaining threshold; (iii) no gas flow within the valve integrated pressure regulator device is detected; (iv) gas connections are disconnected or tubing is kinked; (v) one or more sensors or other components of the valve integrated pressure regulator device are malfunctioning; (vi) low battery charge is detected; (vii) gas temperatures are not within prescribed temperature ranges; (viii) gas flow conditions are inconsistent with flow setting; (ix) MRI field is detected; and (x) anomalies involving gas type, gas expiration date, cylinder condition are detected. of gas are not within prescribed ranges.

21. The valve integrated pressure regulator assembly of claim 1 wherein the valve integrated pressure regulator device further comprises a wireless communications module, and the visual alert indicator in is activated upon receipt of an external signal via the wireless communications module.

22. The valve integrated pressure regulator assembly of claim 1, wherein the valve integrated pressure regulator device further comprises a fill port configured to introduce a gas to the cylinder during a fill mode and wherein the visual alert indicator further comprises a light source configured to emit one or more colors of light and wherein the valve integrated pressure regulator device during the fill mode.
